(19) United States
(12) Patent Application Publication
(10) Pub. No.: US 2011/0311040 A1
(43) Pub. Date: Dec. 22, 2011

(54) Voice Transmitter-Receiver

(76) Inventor: Kuo-Chung CHEN, Taipei Hsien (TW)

(21) Appl. No.: 12/194,222

(22) Filed: Aug. 19, 2008

(30) Foreign Application Priority Data
May 15, 2008 (TW) 097208460

(51) Int. Cl. H04M 1/00

(52) U.S. Cl. 379/420.02

(57) ABSTRACT

An improved voice transmitter-receiver, a plug of which has a clamping portion at a front end thereof, and a connecting socket is located on an electronic device. A mounting hole is located at an outer side of the connecting socket, thereby enabling the voice transmitter-receiver to use the plug to plug into the connecting socket of the electronic device and clamp into the mounting hole of the connecting socket by means of the clamping portion on the plug, thus connecting and fixedly locking the voice transmitter-receiver to the electronic device to prevent the plug of the voice transmitter-receiver from being inadvertently pulled out or coming away from the connecting socket of the electronic device.

### BACKGROUND OF THE INVENTION

(a) Field of the Invention

The present invention relates to an improved voice transmitter-receiver, and more particularly to a structure of a plug for a voice transmitter-receiver that enables the plug to be connected and fixedly locked to an electronic device to prevent the plug of the voice transmitter-receiver from being inadvertently pulled out, or prevent the plug coming away from a connecting socket of the electronic device.

(b) Description of the Prior Art

Referring to FIG. 1, which shows a voice transmitter-receiver of the prior art, in which a voice transmitter-receiver 10 is fitted with a plug 11 that enables connection with a connecting socket of an electronic device (such as: a wireless communication device, a computer, and the like) (not shown in the drawing), thereby enabling the voice transmitter-receiver 10 to effect an electrical connection with the electronic device and realize a communication function for the transmitting and receiving of voices. The plug 11 is fitted with a signal line 12, one end of which is connected to the plug 11, and the other end is connect to a voice transmitter-module 13 (earphone/microphone). When in use, the plug 11 is connected to the connecting socket of the electronic device, thereby enabling use of the earphone of a voice transmitter-module 13 to receive voices, and use of the microphone to transmit voices.

However, the plug 11 of the voice transmitter-receiver 10 of the prior art is plugged directly into the connecting socket of the electronic device, and is not provided with any structure that enables locking of the plug 11 to the connecting socket of the electronic device, thereby resulting in the plug 11 being easily inadvertently pulled out, or the plug 11 coming away from the connecting socket of the electronic device. Hence, the prior art is considerably inconvenient in use.

### SUMMARY OF THE INVENTION

Hence, in light of the shortcomings of the aforementioned prior art, the inventor of the present invention, having accumulated knowhow and manufacturing experience of a diverse range of voice transmitter-receivers, attentively researched various methods to resolve the shortcomings, which, following continuous research and improvements, culminated in the design of a completely new improved voice transmitter-receiver.

One objective of the present inventions is to provide an improved voice transmitter-receiver that enables a plug to be connected and fixedly locked to an electronic device and prevent the plug of the voice transmitter-receiver from being inadvertently pulled out, or prevent the plug coming away from a connecting socket of the electronic device.

According to the aforementioned objective, a voice transmitter-receiver of the present invention comprises a plug, and a signal line is fitted to the plug; one end of the signal line is connected to the plug, while the other end is connected to a voice transmitter-module. A connecting socket is located on the electronic device connected to the voice transmitter-receiver, and a mounting hole is located at an outer side of the connecting socket; the mounting hole is internally provided with a connector. A clamping portion, which functions in conjunction with the mounting hole, is located at a front end of the plug, thereby enabling the voice transmitter-receiver to use the plug to plug into the connecting socket of the electronic device and clamp into the mounting hole of the connecting socket by means of the clamping portion on the plug, thus connecting and fixedly locking the voice transmitter-module to the electronic device, which effects a communication function to enable transmitting and receiving of voices. Accordingly, connecting and fixedly locking the plug of the voice transmitter-receiver to the electronic device enables preventing the plug of the voice transmitter-receiver from being inadvertently pulled out or come away from the connecting socket of the electronic device, thereby achieving the objective to prevent the voice transmitter-receiver from accidentally coming away.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an external elevational view of a voice transmitter-receiver of the prior art.

FIG. 2 is an external elevational view of a preferred embodiment of a voice transmitter-receiver of the present invention.

FIG. 3 is a schematic view of the voice transmitter-receiver of the present invention in use.

FIGS. 4a, 4b and 4c are schematic views depicting consecutive operations in assembling the voice transmitter-receiver according to the present invention.

FIGS. 5a and 5b are schematic views depicting consecutive operations in disassembling the voice transmitter-receiver according to the present invention.

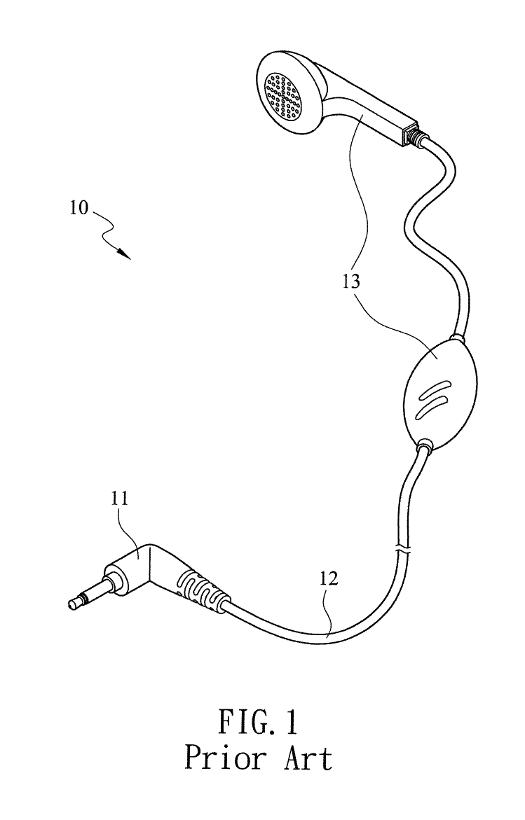

### DETAILED DESCRIPTION OF THE PREFERRED EMBODIMENTS

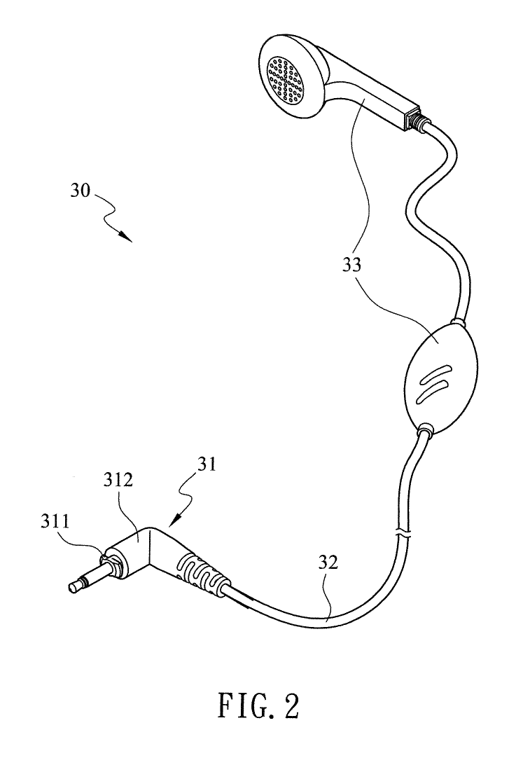

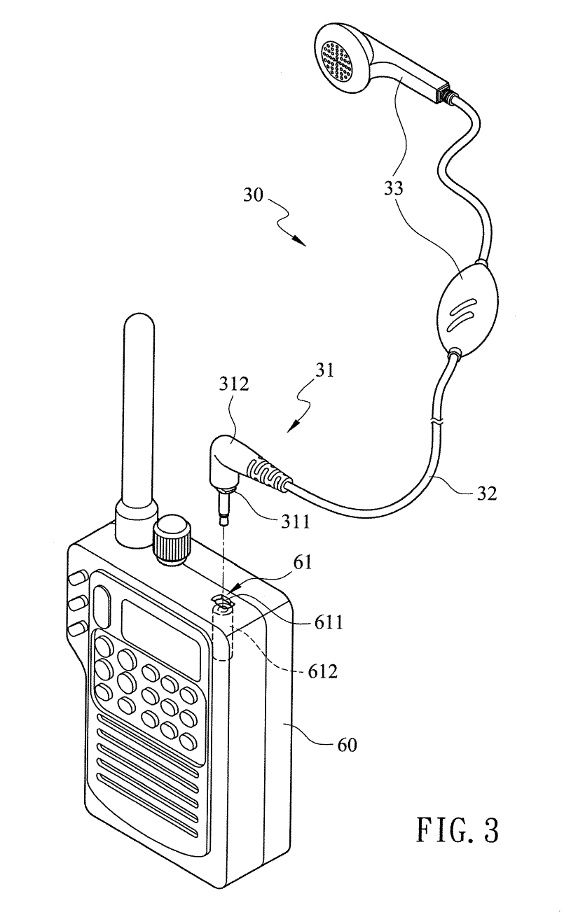

The present invention relates to an improved voice transmitter-receiver. Referring to FIGS. 2 and 3, which show a voice transmitter-receiver 30 of the present invention fitted with a plug 31. The plug 31 is used to plug into a connecting socket 61 of an electronic device 60 (such as: a wireless communication device, a computer, a mobile phone, a MP3 (MPEG Audio Layer III) personal stereo, and the like), thereby enabling the voice transmitter-receiver 30 to effect an electrical connection with the electronic device 60, and achieve a communication function to enable the transmitting and receiving and of voices.

A signal line 32 is fitted to the plug 31, and one end of the signal line 32 is connected to the plug 31, while the other end is connected to a voice transmitter-module 33 (in a preferred embodiment of the present invention, the voice transmitter-module 33 comprises an earphone and a microphone). A mounting hole 611 is located at an outer side of the connecting socket 61 located on the electronic device 60 connected to the voice transmitter-receiver 30. The mounting hole 611 is internally provided with a connector 612, moreover, a clamping portion 311 that functions in conjunction with the mounting hole 611 is located at a front end of the plug 31, thereby enabling the voice transmitter-receiver 30 to use the plug 31 to plug into the connecting socket 61 of the electronic device 60 and clamp into the mounting hole 611 of the connecting socket 61 by means of the clamping portion 311 on the plug 31, thereby fixedly connecting the voice transmitter-module 33 to the electronic device 60, which effects a communication function to enable transmitting and receiving of voices (that is, the earphone of the voice transmitter-module 33 is used to receive voices and the microphone to transmit voices). Accordingly, connecting and fixedly locking the plug 31 of the voice transmitter-receiver 30 to the electronic device 60 enables preventing the plug 31 of the voice transmitter-receiver 30 from being inadvertently pulled out or come away from the connecting socket 61 of the electronic device 60, thereby achieving the effectiveness and objective to prevent the voice transmitter-receiver 30 from accidentally coming away.

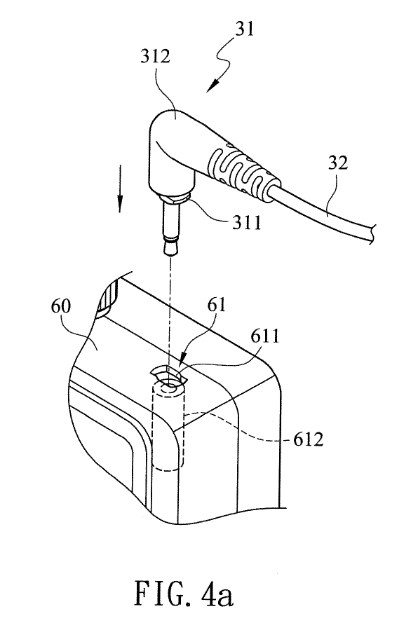

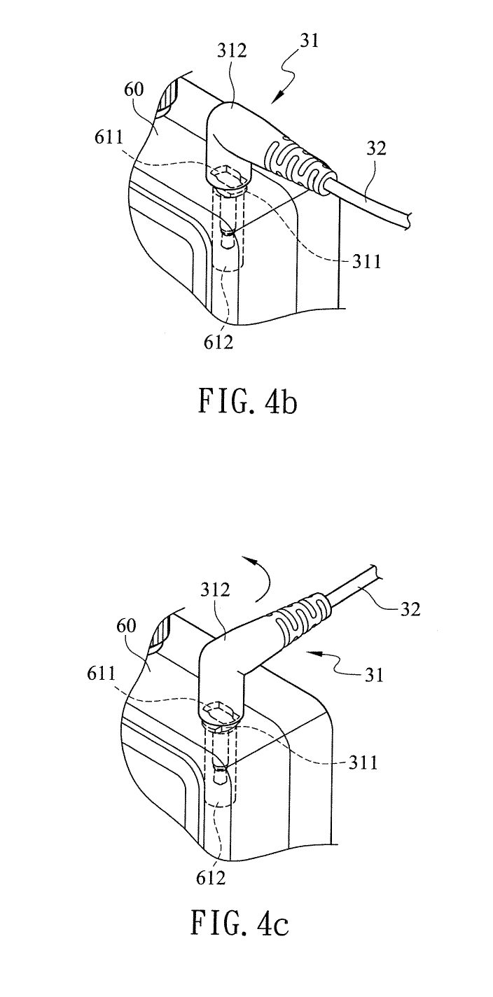

Referring to FIGS. 4a, 4b and 4c, a space is maintained between the mounting hole 611 of the electronic device 60 and the connector 612. The mounting hole 611 is a rectangular hole, and the clamping portion 311 of the plug 31 of the voice transmitter-receiver 30 (shown in the FIG. 2) is a rectangular clamping piece that functions to correspond with the mounting hole 611. A space is maintained between the clamping portion 311 and a holding portion 312 of the plug 31, and the space is slightly smaller than the space between the mounting hole 611 of the electronic device 60 and the connector 612. Accordingly, when connecting the plug 31 of the voice transmitter-receiver 30 to the connecting socket 61 of the electronic device 60, the clamping portion 311 of the plug 31 penetrates within the mounting hole 611, thereby causing the connecting pin of the plug 31 to connect with the connector 612 of the connecting socket 61 and form an electrical connection therewith, and rotating the plug 31 through a 90 degree angle causes the rectangular clamping piece of the clamping portion 311 to become fixedly locked within the mounting hole 611, thereby preventing the plug 31 from being pulled out and coming away.

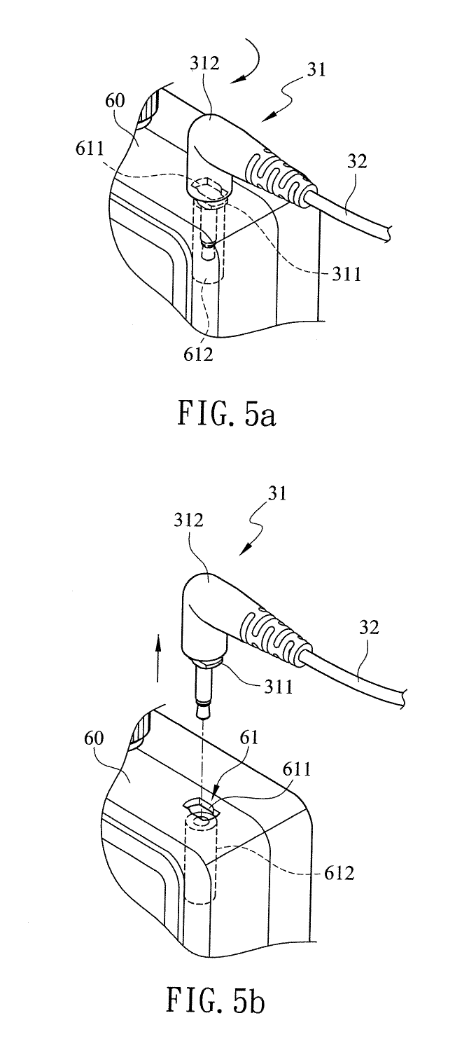

Referring to FIGS. 5a and 5b, when pulling out the plug 31, the plug 31 is rotated through a 90 degree angle in a direction opposite to that when locking the plug 31, thereby enabling the clamping portion 311 to pass through the mounting hole 611 and be directly pulled out from the mounting hole 611 of the electronic device 60.

Referring again to FIGS. 2 and 3, the voice transmitter-module 33 can also be a pair of earphones, a single earphone, a microphone and earphone or a single microphone.

In conclusion, the improved voice transmitter-receiver of the present invention is assuredly provided with an innovative structure not found in the prior art. Moreover, no similar products have been seen in any publication or in the market; the present invention is thus provided with undoubted originality. In addition, the present invention is provided with unique characteristics and functionality that are without comparison in the prior art. Hence, the incomparable advancement of the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A voice transmitter-receiver, comprising:
a plug, the plug is used to plug into a connecting socket of an electronic device, and a signal line is fitted to the plug; one end of the signal line is connected to the plug, and the other end is connected to a voice transmitter-module, the connecting socket is located on the electronic device connected to the voice transmitter-receiver, and a mounting hole is located at an outer side of the connecting socket, the mounting hole is internally provided with a connector;
a clamping portion located at a front end of the plug, and the clamping portion functions in conjunction with the mounting hole of the connector, which enables the voice transmitter-receiver to use the plug to plug into the connecting socket of the electronic device and clamp into the mounting hole of the connecting socket by means of the clamping portion on the plug, thereby connecting and fixedly locking the voice transmitter-module to the electronic device, which effects a communication function to enable the transmitting and receiving of voices.

2. The voice transmitter-receiver according to claim 1, wherein a space is maintained between the mounting hole of the electronic device and the connector, the mounting hole is a rectangular hole, and the clamping portion of the plug of the voice transmitter-receiver is a rectangular clamping piece that functions to correspond with the mounting hole; a space is maintained between the clamping portion and a holding portion of the plug, and the space is slightly smaller than the space between mounting hole of the electronic device and the connector.

3. The voice transmitter-receiver according to claim 1, wherein the voice transmitter-module is a pair of earphones, a single earphone, a microphone and earphone or a single microphone.
